(19) United States
(12) Patent Application Publication
(10) Pub. No.: US 2016/0380856 A1
(43) Pub. Date: Dec. 29, 2016

(54) SYSTEMS AND METHODS FOR TRACKING DEVICES STATUS AND MALFUNCTIONS IN MACHINE-TO-MACHINE NETWORKS

(71) Applicant: QATAR UNIVERSITY QSTP-B, Doha (QA)

(72) Inventors: Elyes BEN HAMIDA, Doha (QA); Fethi FILALI, Doha (QA)

(21) Appl. No.: 14/749,662

(22) Filed: Jun. 25, 2015

(51) Int. Cl. H04L 12/26

(52) U.S. Cl. CPC H04L 43/0823; H04L 43/10; H04L 43/065

(57) ABSTRACT

Disclosed are systems, methods, and apparatus for tracking devices status and malfunctions in a Machine-to-Machine (M2M) network. The system comprises: at least a controller module capable of tracking devices status and malfunctions, wherein the controller module having at least one of a processing module, a tracking module, and a database module; at least a device attached to a mobile or a static entity, wherein the device is having at least one of at least a sensor and at least a device communication module; at least a data profiles module capable of describing at least one of the device and at least the sensor; at least a device heartbeat profile and at least a data accuracy profile associated with the data profiles module; and at least a tracking module capable of tracking devices status and malfunctions. The device is capable of collecting the data records generated by the sensors and transmitting the collected data records to the controller module.

### FIELD OF THE INVENTION

The present invention relates to systems and methods for tracking devices status and malfunctions in Machine-to-Machine (M2M) networks in cost effective, efficient, secure, and environment friendly manner

### BACKGROUND OF THE INVENTION

M2M networks are considered as the main enabler of the future Internet of Things (IoT) in which smart objects will be connected at anytime and anywhere to Internet and will share data with little, or no human intervention. According to recent studies, it is expected that nearly 50 billion devices will be connected to the IoT by 2020. The envisioned IoT applications are still in their early stages, though several applications have already been deployed in various industries around the world, among them automotive, healthcare, home and industrial automation, security, and many others.

However, several main challenges need to be overcome in order to unlock the tremendous potential of the IoT, and to enable the wide scale deployment and adoption of IoT applications. One of the biggest challenges consists in the efficient management of the deployed smart objects in terms of the tracking of their availability status (i e online, offline) and the detection of malfunctions within their sensors.

Prior art discloses numerous techniques for tracking devices status, for example, US Publication No. 20060033606, discloses methods and apparatus for determining the status of a device_for determining the status of a networked e.g., a networked RFID device. In some embodiments of the invention, a customized packet is used to transmit a “heartbeat” from each of a plurality of networked devices to a server. Some such embodiments use a customized syslog packet for the heartbeats. The heartbeat includes identification information regarding the device, e.g., the unique electronic product code (“EPC”) of the device. Here the status of a device is detected on the basis of control packets, such as heartbeat packets. The publication fails to teach or suggest detection of device status based on transmitted data records and without the need of control packets. Further, the publication also fails to suggest means to detect and track the detailed status of each of its sensors.

The WOPO Publication No. WO 2006102253A2 discloses apparatus and methods for managing predetermined malfunction events in a wireless device operating in a wireless communications network. Malfunction event data and operational data are recorded by the wireless device based on a selected malfunction event tracking configuration. Further, a recovery module associated with the wireless device operates to attempt to recover information leading up to and including the malfunction event. The collected information may be transmitted to a user manager in the form of a malfunction event log. The malfunction event log may be analyzed to characterize the malfunction. Here, the malfunction detection process occurs on the device. The publication fails to teach or suggest user defined profiles based detection of device malfunctions by a server which relies on the real-time and/or historical analysis of the received devices' data records to check the status of these devices and their sensors, where each device might have one global status and as many detailed status as sensors

The prior art fail to disclose any efficient technique for tracking devices status and malfunctions in Machine-to-Machine (M2M) networks which rely on the data which are being shared by the deployed devices in order to enable the real-time and/or historical tracking of their availability status and to enable the timely detection of malfunctioning devices or sensors.

In view of the drawbacks inherent in the prior art, there exists need of a low complexity and efficient means for tracking devices status and malfunctions in M2M networks which rely on the data which are being shared by the deployed devices in order to enable the real-time and/or historical tracking of their availability status and to enable the timely detection of malfunctioning devices or sensors.

### SUMMARY OF THE INVENTION

In view of the foregoing disadvantages inherent in the prior-art, the general purpose of the present invention is to provide systems and methods for tracking devices status and malfunctions in Machine-to-Machine (M2M) networks, that is configured to include advantages of the prior art and to overcome the drawbacks inherent in the prior art offering some added advantages.

In one aspect, the present invention provides a system for tracking devices status and malfunctions in a Machine-to-Machine (M2M) network. The system comprises: at least a controller module capable of tracking devices status and malfunctions, wherein the controller module having at least one of a processing module, a tracking module, and a database module; at least a device attached to a mobile or a static entity, wherein the device is having at least one of at least a sensor and at least a device communication module; at least a data profiles module capable of describing at least one of the device and at least the sensor; at least a device heartbeat profile and at least a data accuracy profile associated with the data profiles module; and at least a tracking module capable of tracking devices status and malfunctions. The device is capable of collecting the data records generated by the sensors and transmitting the collected data records to the controller module.

In another aspect of the present invention, the tracking module is capable of: analyzing at least one of the historical and real-time data notifications, available data profiles module and data models; tracking at least one of the real-time and historical devices availability status during the previous period of time; tracking at least one of the real-time and historical status of the sensors; detecting the malfunctioning sensors; and updating status of devices according to detected changes.

In another aspect, the present invention provides a method for tracking of devices availability and malfunction. The method comprises the steps of: extracting at least one of a device heartbeat profiles and a data accuracy profiles; extracting notifications for at least the device for a previous time period; setting the device availability status to one of online and offline; and setting the status of the corresponding data type or group of data types to any one of ‘unknown’, ‘working’, ‘malfunctioning or blacklisted’ according to predefined data accuracy profiles rules.

In another aspect of the present invention, the method for tracking of devices availability and malfunction comprises the steps of: receiving or requesting the devices data records from at least one of at least the device and at least an external data sources; decoding and validating the data records received from at least one of the devices and the external data source; generating and storing at least a device status notification; filtering the received devices data records based on at least one of a corresponding data type value, time and location filter expression; storing the received device data records in a database module; and storing at least a device status notification in the database module.

In yet another aspect, the present invention provides an apparatus for tracking at least a device status and malfunctions in the M2M network. The apparatus comprises: at least a processing module capable of processing data received from at least one of the device and an external data source; at least a data profiles module capable of describing at least one of the device and at least a sensor of the device; and at least a tracking module capable of tracking status and malfunctions of the device and device sensors, wherein the data profiles module associated with at least one of a device heartbeat profile and a data accuracy profile, wherein the data accuracy profile is associated to at least one of a data type and at least a data model, wherein the heartbeat profile is associated to at least one of at least a device detail and at least a device template, wherein a database module is capable of storing and processing at least one of the data profile module, the device heartbeat profile, the data accuracy profile, and notification processed by the processing module.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1A illustrates an exemplary block diagrams of a system for tracking devices status and malfunctions, according to an exemplary embodiment of the present invention;

FIG. 1B illustrates an exemplary environmental diagram of the system for tracking devices status and malfunctions, according to an exemplary embodiment of the present invention;

FIG. 2A illustrates a data profile module overview, according to an exemplary embodiment of the present invention;

FIG. 2B illustrate the data profile module, according to an exemplary embodiment of the present invention;

FIG. 2C illustrate description of the data profile module, according to an exemplary embodiment of the present invention;

FIG. 3 illustrates an exemplary description of a device heartbeat profile and a device accuracy profile modules, according to an exemplary embodiment of the present invention;

FIG. 4A illustrates interactions between the different entities of the data profile module, according to an exemplary embodiment of the present invention;

FIG. 4B illustrates an exemplary description of entities of the data profile module, according to an embodiment of the present invention;

FIG. 4C illustrates an exemplary relationship between entities of devices data profile module, according to an embodiment of the present invention;

FIG. 4D illustrates an example of device and data types notifications, according to an exemplary embodiment of the present invention;

FIG. 5A illustrates a method for tracking devices status and malfunctions, according to an exemplary embodiment of the present invention;

FIG. 5B illustrates a method for processing devices data, according to an exemplary embodiment of the present invention; and

FIG. 6 illustrates an apparatus for tracking the devices status and malfunctions, according to an exemplary embodiment, the present invention.

### DETAILED DESCRIPTION OF THE INVENTION

The exemplary embodiments described herein in detail for illustrative purposes are subject to many variations in structure and design. It should be emphasized, however, that the present invention is not limited to a particular systems and methods for tracking devices status and malfunctions in Machine-to-Machine (M2M) networks as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including”, “comprising” or “having” and variations thereof herein are meant to encompass the items listed thereafter and equivalents thereof as well as additional items. The terms, “a” and “an” herein do not denote a limitation of quantity, but rather denote the presence of at least one of the referenced item. Further, the term “plurality” herein denotes the presence of more than one of the referenced item.

The terminologies herein after referred to as, “Machine to Machine” for “M2M”, “devices heartbeat profiles” for “DHP profiles” or “DHP”, “data accuracy profiles” for “DAP profiles” or “DAP”.

The present invention provides system, methods, and an apparatus for tracking devices status and malfunctions in a communication network environment 300, for example, Machine-to-Machine (herein after referred to as “M2M”) networks, in a low complexity, cost effective, and environment friendly manner.

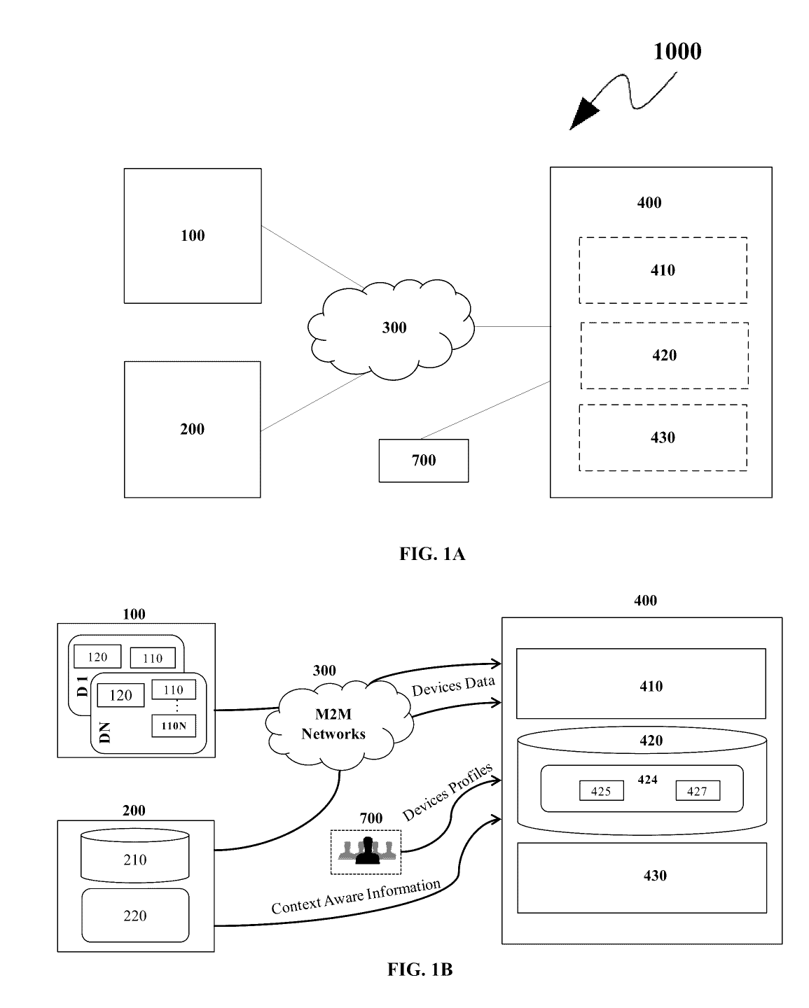

Referring to FIGS. 1A-1B which illustrate a system 1000 for tracking devices status and malfunctions in the M2M network environment 300, according to an exemplary embodiment of the present invention. The system 1000 comprises: at least a controller module 400; and at least one of at least a device 100 and at least an external data source 200, wherein the controller module 400 is communicable connected with at least one of the device 100 and the external data source 200 through the M2M network 300.

The controller module 400 having at least one of at least a processing module 410, at least a data profile module 422 associated with at least a database module 420, and at least a tracking module 430. The database module 420 is capable of storing and processing at least one of the data profiles module 422, the DHP 425, and the DAP 427.

The device 100 having at least one of at least a sensor 110 and at least a device communication module 120. The device 100 is capable of collecting the data records generated by the sensors 110 and transmitting the collected data records to the controller module 400 through the M2M network 300.

The data profile module 422 capable of: describing data profiles of at least one of the device 100 and the sensor 110; and processing data received from at least the device 100. The data profile module 422 having at least one of a device heartbeat profile 425 and a data accuracy profile 427.

The tracking module 430 is capable of tracking devices status and malfunctions. The tracking module 430 may be associated with the data profile module 422, the device heartbeat profile 425, and a data accuracy profile 427.

The data profiles module 422, the heartbeat profile 425, and the data accuracy profile 427 are defined and/or configured by external or end users 700. The end users 700 include devices administrators.

According to an exemplary embodiment of the present invention, a plurality of devices 100 (shown as D1, . . . DN in FIG. 1B), may be deployed on the field or attached to static and/or mobile entities, for example, vehicles, machinery, utility meters, digital billboards, humans, buildings, street lights, animals, plants, etc. Each device 100 includes at least the sensor 110 and at least the device communication module 120.

A plurality of sensors 110 (shown as 110, . . . 110N in FIG. 1B) may be associated with the device 100 according to the requirement. Each sensor 110 is capable of sensing or detecting at least a characteristic in its surrounding environment, for example, temperature, vibration, speed, heartbeat, etc.

The device communication module 120 is capable of at least collecting data records generated by the sensor 110, to properly describe the collected data records based on the user's defined device data profiles, i.e. a data type 112, a data model 114, a device template 116, and a device detail 118.

Each device 100 is capable of collecting the data records generated by the sensors 110, . . . 110N and transmitting the collected data records to the controller module 400 through the M2M network 300. The M2M network 300 may be based on any proprietary and/or standardized, wired and/or wireless network communication technology. The M2M network 300 is capable of connecting the deployed devices 100 and/or the external data sources 200 to the controller module 400.

The external data source 200 may include at least one of a database 210, apps, systems 220 or any combination thereof. The external data source 200 may already contains data records collected from deployed devices, other than the devices 100 which exclusively managed and tracked by the controller module 400. The external data source 200 is communicably connected to the controller module 400 and capable of transmitting at least one of stored/historical context based or context aware information and data records of deployed devices, to the controller module 400 through the M2M network 300. The context based information includes any information related to a particular context, for example, the context based information including but not limiting to weather, time, season, location, etc.

The external data source 200 may comprise in a third party entity which may be already collecting data from other deployed devices (other than the devices 100). Upon the request of the controller module 400, the external data source 200 may deliver its stored data records, such that the controller module 400 may track the historical and/or real-time status of the involved devices and sensors.

According to an exemplary embodiment of the present invention, a plurality of external data sources 200 may be communicably connected to the controller module 400 to transmit data records/context based information through the M2M network 300.

According to an exemplary embodiment of the present invention, the controller module 400 capable of enabling the external users or administrators 700 to define and configure the devices 100 and the data profile modules 422 or data records models along with their corresponding DHP profile 425 and the DAP profile 427.

The controller module 400 is capable of interacting with the M2M networks 300 to decode and store the data records in the database module 420, which are received from at least one of the remote devices 100 and the external data sources 200. These data records are further translated into notifications which are also stored in the database module 420 to enable further data analysis and processing.

The processing module 410 is capable of receiving, decoding and storing devices data in to the database module 420. The processing module 410 receives data records from at least one of the remote devices 100 and the external data sources 200, and translates them into notifications based on the accuracy of the received data and the availability of the remote devices 100.

The tracking module 430 is capable of at least one of: tracking the real-time and/or historical devices availability status (i.e. ONLINE and OFFLINE), based on at least one of the stored notifications, the user defined DHP 425 and the corresponding context based information; and tracking at least one of the real-time and historical device's data types (or sensors) status (i.e. WORKING, MALFUNCTIONING, BLACKLISTED, UNKNOWN), based on at least one of the stored notifications, the user defined DAP 427 and the corresponding context based information received from the external data sources 200. The tracking process may be done in real-time or periodically or at specific time instants or range in the past (historical) or based on specific events or requests. In such cases, for every evaluated time period, the device 100 may be detected as online or offline.

The tracking module 430 is capable of periodically: analyzing at least one of the historical and the real-time data notifications, available profiles, and data models of devices 100; tracking at least one of the real-time and historical devices availability status during the previous period of time using the DHP 425 and the context based information; tracking at least one of the real-time and historical status of sensors 110 . . . 110N of devices 100 based on their DAP 427 and the context based information; detecting the malfunctioning sensors 110 . . . 110N based on the defined DAP 427; and updating status of devices 100 according to detected changes in status of devices 100. The said status includes working, malfunctioning, blacklisted, unknown.

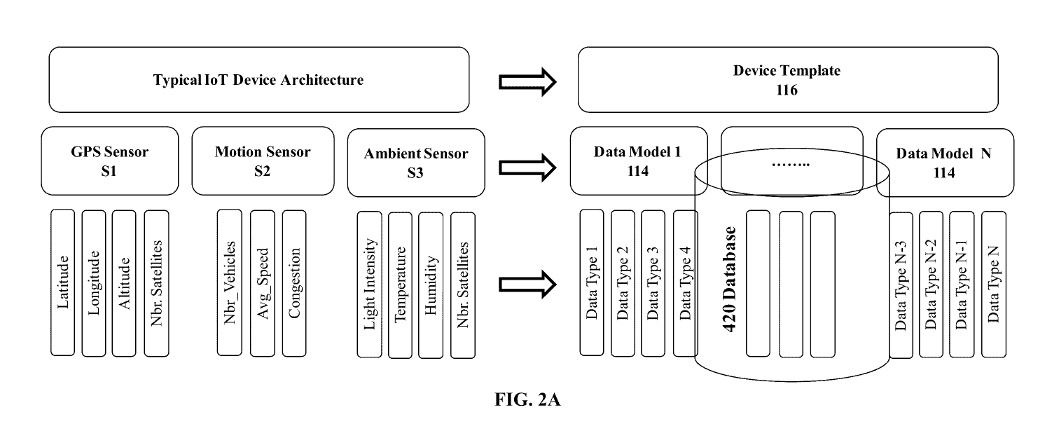

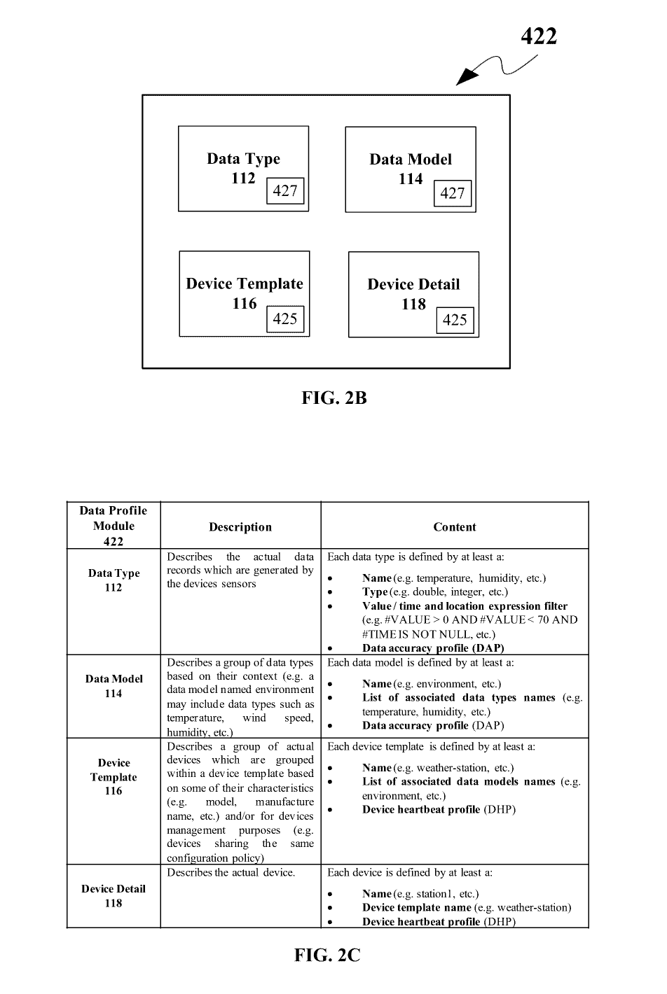

Referring to FIGS. 2A, 2B, and 2C which illustrate exemplary data profile module 422, according to an exemplary embodiment of the present invention. The data profile module 422, which is associated with the devices 100, is capable of tracking the status of any device 100, regardless of its hardware and software architectures.

The data profile module 422 may comprise a plurality of sub modules or entities including the data type 112, the data model 114, the device template 116, and the device detail 118. The data profile module 422 may also include more entities defined by the users 700 according to the requirement.

The data type 112 describes the actual data records which are generated by the device sensors 110. Each data type 112 may includes: at least a name, for example, temperature, humidity, pressure, etc; at least a type, for example, double, integer, etc; at least a Value/time and location expression filter, for example, #VALUE>0 AND #VALUE<70 AND #TIME IS NOT NULL, etc; and at least the DAP 427.

The data model 114 describes a group of data types based on their context, for example, a data model 114 named environment may include data types 112 such as temperature, wind speed, humidity, etc. Each data model 114 may include: at least a name, for example, environment, etc; at least a list of associated data types names, for example, temperature, humidity, etc; and at least the DAP 427.

The device template 116 describes a group of actual devices 100 which are grouped within a device template based on: some of their characteristics, for example, model, manufacture name, etc; and/or for devices management purposes, for example, devices sharing the same configuration policy. Each device template 116 may be defined by: at least a name, for example, weather-station, etc; at least a list of associated data models names, for example, an environment, etc; and the DHP 425.

The device detail 118 describes the actual device 100. Each device 100 may be defined by device detail 118 which includes: at least a name, for example, station1, etc; at least a device template name, for example, weather-station; and at least the DHP 425.

The DHP 425 specifies the main information and rules that are required to determine the device 100 availability status (e.g. online, offline, unknown). The DAP 427 specify the main information and rules to detect the malfunctioning sensors 110, . . . 110N, associated with the deployed devices 100 (e.g. D1, . . . DN as shown in FIG. 1B). The DHP 425 may be associated to one or multiple group of device(s) 100. The DAP 427 may be associated to one or multiple group of data type(s) 112.

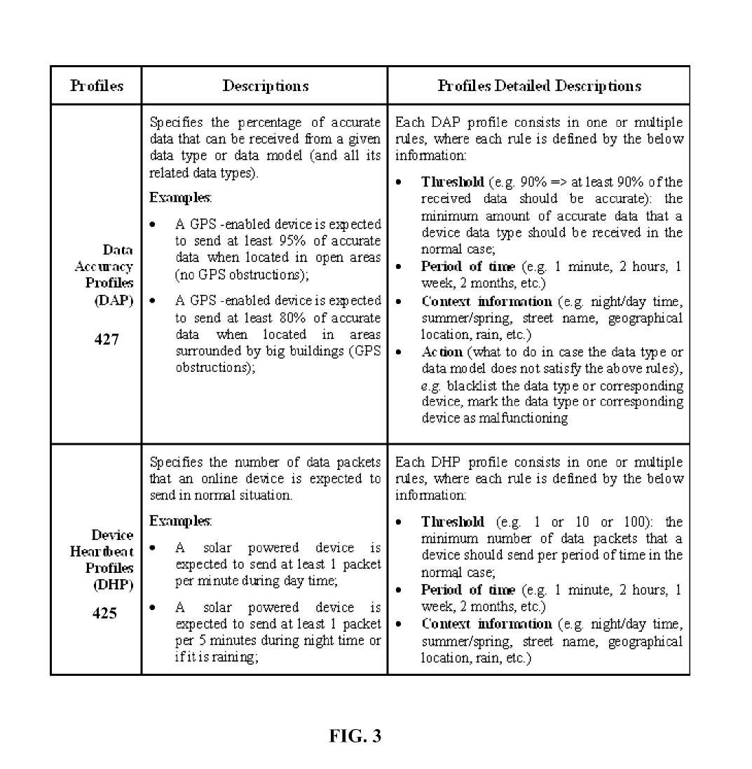

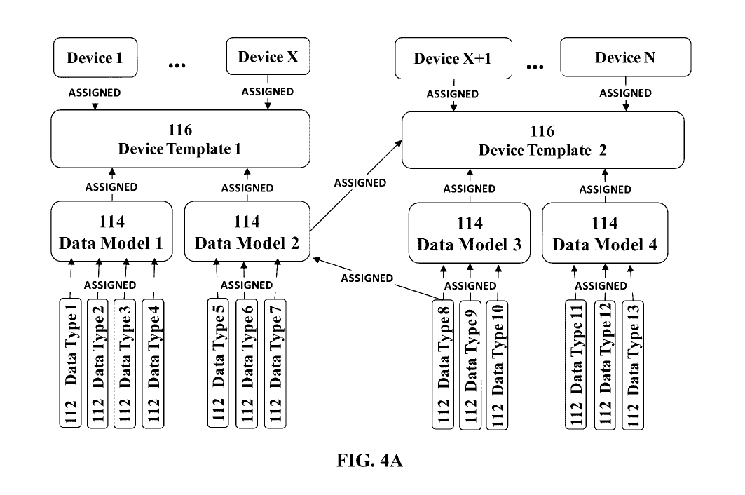

Referring to FIG. 3 which illustrates the DHP 425 and the DAP 427, according to an exemplary embodiment of the present invention. In order to be able to track the status of any devices 100, regardless of its hardware and software architectures, the DHP 425 and the DAP 427 may be defined and associated to certain entities of the data profile module 422. The DHP 425 and the DAP 427 may be based on at least one of the characteristics of the devices 100 and contextual information coming from the external data sources 200.

According to an exemplary embodiment of the present invention, the DAP 427 specifies the percentage of accurate data that is expected to be received in normal situations from a given data type 112, data model 114 and all data types, for example, data type 1, data type 2, . . . data type N, related to the data model 114. For example, a GPS enabled device is expected: to send at least 95% of accurate data when located in open areas (no GPS obstructions); and to send at least 80% of accurate data when located in areas surrounded by big buildings (GPS obstructions).

According to an exemplary embodiment of the present invention, each DAP 427 may consists in one or multiple rules, wherein each rule is defined by certain information, for example, threshold, period of time, context information, action. The threshold is the minimum amount of accurate data that a device data type 112 may be received in the normal case, for example, threshold 90%=>at least 90% of the received data is expected to be accurate. The period of time may be defined as 1 minute, 2 hours, 1 week, 2 months, etc. The context information may be defined as night/day time, summer/spring, street name, geographical location, rain, etc. The action such that what to do in case the data type 112 or the data model 114 does not satisfy the above rules, may be defined, for example, blacklist the data type 112 or corresponding device 100, mark the data type 112 or corresponding device 100 as malfunctioning.

According to an exemplary embodiment of the present invention, the DHP 425 may specify the number of data packets that an online device is expected to send in normal situation, for example, a solar powered device 100 is expected to send at least 1 packet per minute during day time and at least 1 packet per 5 minutes during night time or if it is raining.

Each DHP 425 comprises one or multiple rules, where each rule is defined by certain information, for example, threshold, period of time, context information. The threshold, for example, 1 or 10 or 100, refers the minimum number of data packets that a device may send per period of time in the normal case. The period of time may be defined as 1 minute, 2 hours, 1 week, 2 months, etc. The context information may include night/day time, summer/spring, street name, geographical location, rain, etc. The DAP 427 and the DHP 425 are defined and configured by the end users 700 (e.g. devices administrators), and are stored in a database, for example, the database module 420.

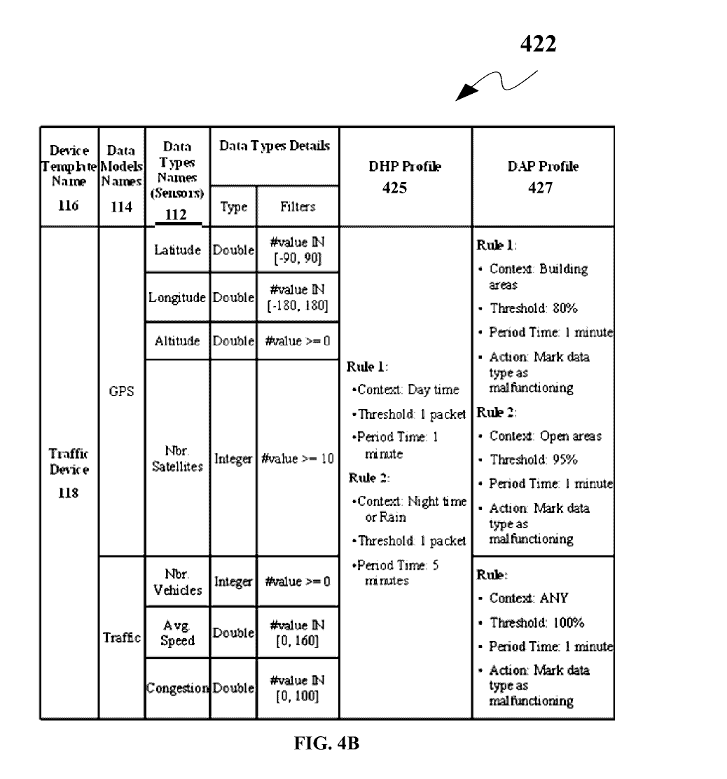

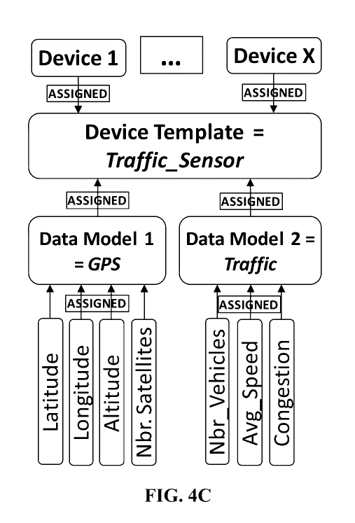

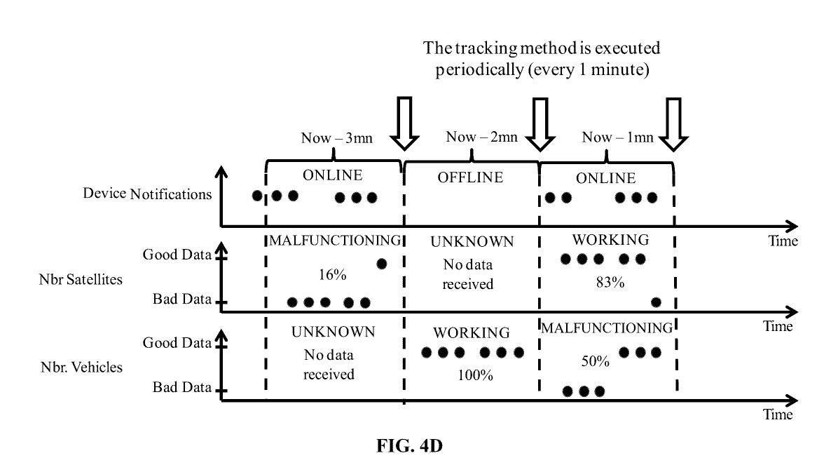

Referring to FIG. 4A which illustrates interactions between the different entities of the data profile module 422, according to an exemplary embodiment of the present invention. Each data type 112 may be associated to one or multiple data model(s) 114, wherein the DAP 427 defined at the data type level overwrites the DAP 427 defined at the corresponding data model 114. Each data model 114 may be associated to one or multiple device template(s) 116. Each device 100 may be associated to only one device template 116, wherein the DHP 425 defined at the device level overwrites the DHP 425 defined at the corresponding device template 116. All the above data models 114 and profiles are defined by the end users 700, and are stored in the database module 420.

Referring to FIG. 4B to 4D, wherein: FIG. 4B illustrates an exemplary description of entities of the data profiles module 422; FIG. 4C illustrates an exemplary relationship between entities of data profile module 422; and FIG. 4D illustrates an exemplary device and data types notifications, according to exemplary embodiments of the present invention.

An exemplary implementation of an embodiment of the present invention may, for example, include a scenario related to the real-time monitoring of road traffic conditions using solar powered devices which are deployed along the roads, intersections and roundabouts. Each device is powered through an internal battery and solar panel, and includes two sensors: a first sensor that detects the GPS location including the latitude, longitude, altitude and the number of detected GPS satellites; and a second sensor that estimates the traffic conditions in terms of number of detected vehicles, average vehicles speeds, and the congestion level. Furthermore, each device includes a network connector, for example, 3G or 4G modem, to connect to the Internet.

Once the end users 700 properly defined required modules or profiles 422 in the database module 420, the end user or administrator 700 may deploy defined/assigned devices (Device 1 . . . Device X) on the field. As soon as the devices Device 1 . . . Device X start, data may be generated by the different device's sensors and may be transmitted to the controller module 400. Each transmitted data consists in the following information: “data model, data type, data value, and timestamp”. For example, assuming the above data models and profiles (as shown in FIG. 4A), a device 100 may send the below data to the remote controller module 400:
GPS, Latitude, 25.300537, 6/2/2015 3:42 PM
GPS, Longitude, 51.512444, 6/2/2015 3:42 PM
GPS, Altitude, 10, 6/2/2015 3:42 PM
GPS, Nbr Satellites, 6, 6/2/2015 3:42 PM

Once the above data are received by the controller module 400, each data may be decoded and checked against its defined filters (as shown in FIG. 4A):
GPS, Latitude, 25.300537, 6/2/2015 3:42 PM—OK (may be stored in database module)
GPS, Longitude, 51.512444, 6/2/2015 3:42 PM—OK (may be stored in database module)
GPS, Altitude, 10, 6/2/2015 3:42 PM—OK (may be stored in database module)
GPS, Nbr Satellites, 6, 6/2/2015 3:42 PM—FILTERED (may not be stored in database module because Nbr Satellites should be >=10)

Then, notifications will be generated and stored in the database module 420 based on the filtering outcomes: a GOOD_DATA notification will be generated for the data types which passed successfully their filters; whereas a BAD_DATA notification will be generated for the data types which were filtered. In all cases, since the received data (filtered or not), a DEVICE_ONLINE is generated to indicate that the remote device is currently online After, a certain period of time, different notifications may be available in the database module 420 (as shown in the FIG. 4D).

The method 500 for tracking of the devices availability status (i e online or offline) and the status of its corresponding data types 112 may be executed periodically, for example, every 1 minute (as shown in FIG. 4D). At every execution of the method 500, the historical notifications are analyzed against the defined DAP 427 and the DHP 425, and the current status of the device 100 is determined (i e online or offline), as well as the status of each of its sensors 110 (i.e. working, malfunctioning, unknown, etc.). If the status of the device 100 or the sensor 110 is different from the previously computed status, then an alert could be sent to the administrator 700 through any messaging means including but not limiting to email or SMS.

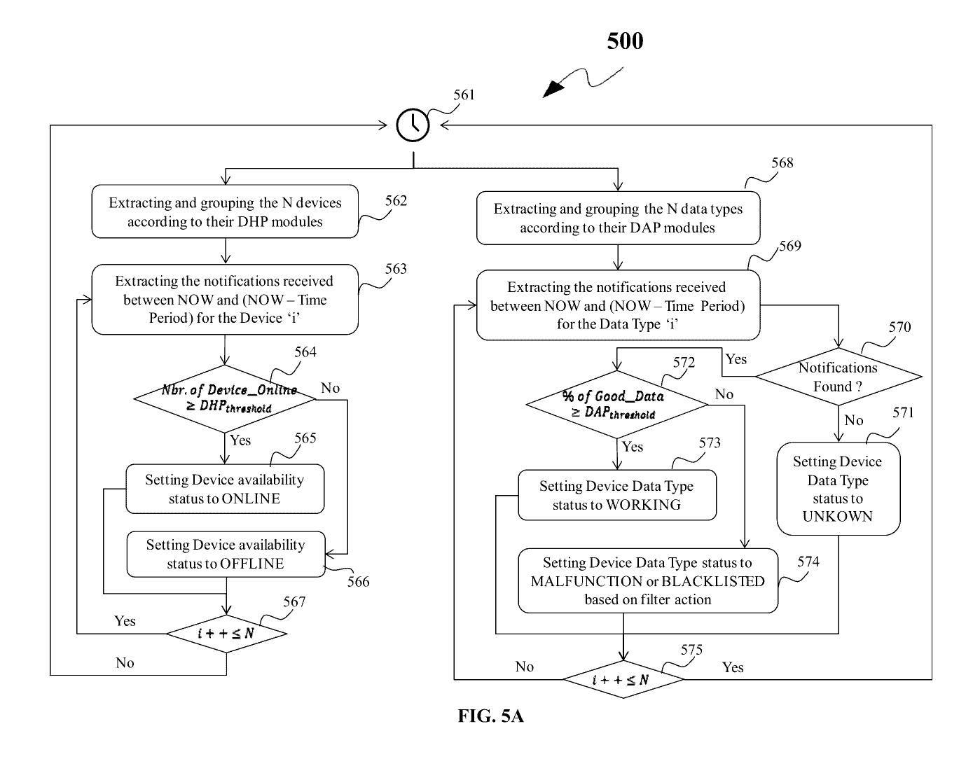

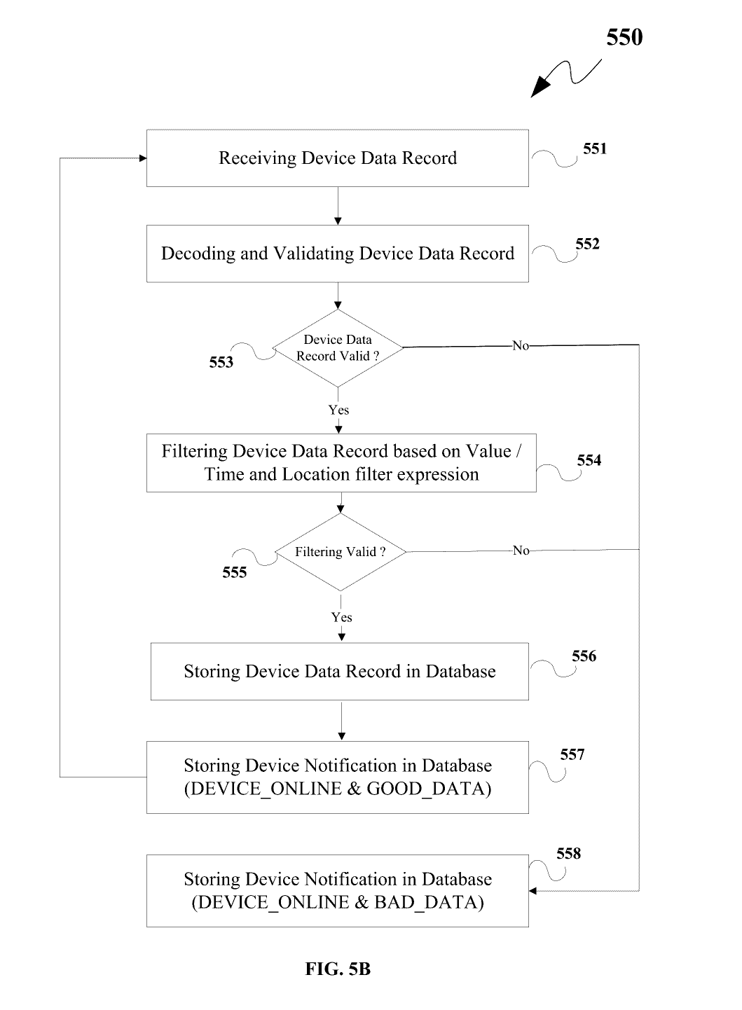

Referring to FIG. 5A which illustrates a method 500 for tracking of the devices availability status (i e online or offline) and the status of its corresponding data types 112 (i.e. working, malfunctioning, blacklisted, unknown), according to an exemplary embodiment of the present invention. The tracking may be done in real-time or periodically or at specific time instants or range in the past (historical) or based on specific events or requests.

The method 500 starts with triggering periodically two main processes, i.e. step 562 and step 568 by a timer at a step 561. The first process start at step 562 with the extraction of the user defined DHP 425 from the database module 420, where devices 100 are grouped based on their profiles, i.e. each group of devices 100 may share the same DHP 425. At a step 563, for each device 100 or group of devices, the corresponding notifications (i.e. DEVICE_ONLINE) may be extracted from the database module 420 for the previous time period (i.e. between NOW and ‘NOW—Time Period’, where ‘time period’ is defined by the DHP 425). At a step 564, if the total number of notifications for a given device 100 or group of devices if higher or equal than the DHP threshold, the device availability status is set to ONLINE at a step 565. Otherwise, the device availability status is set to OFFLINE at a step 566. If more devices 100 or groups of devices need to be tracked at a step 567, the steps 562 to 567 may be executed again, otherwise the whole process may waits for the next execution time at the step 561, which is typically periodic.

According to an exemplary embodiment of the present invention, the second process of the method 500 starts at a step 568 with the extraction of all the available data types 112 along with their respective DAP 427. The DAP 427 is associated to a data type 112 if and only if: this DAP 427 is explicitly associated to that data type 112; or this data type 112 is associated to a data model 114 which is it-self explicitly associated to this DAP 427 (as shown in FIG. 4A). The extracted data types 112 are grouped based on their DAP 427. Then, for each data type 112 or group of data types, the corresponding notifications (i.e. GOOD_DATA and BAD_DATA) are extracted from the database module 420 at a step 569 for the previous time period (i.e. between NOW and ‘NOW—Time Period’, where ‘time period’ is defined by the DAP profile).

According to an exemplary embodiment of the present invention, upon extraction of said corresponding notification for the previous time period at the step 569, three main rules may be checked: 1) if notifications are not found, i.e. no data records were received during this time period at a step 570, the status of the corresponding data type 112 or group of data types is set to UNKNOWN at a step 571; 2) if the amount of accurate notifications (i.e. 100×SUM(GOOD_DATA)/SUM(GOOD_DATA+BAD_DATA)) is higher or equal than the DAP profile threshold, the status of the corresponding data type 112 or group of data types is set to WORKING at a step 573; and 3) if the amount of accurate notifications (i.e. 100×SUM(GOOD_DATA)/SUM(GOOD_DATA+BAD_DATA)) is lower than the DAP threshold, the status of the corresponding data type 112 or group of data types is set to MALFUNCTIONING or BLACKLISTED at a step 574 based on the said DAP 427 action. If more data types 112 or groups of data types need to be tracked at a step 575, the steps 568 to 575 may be executed again, otherwise the whole process waits for the next execution time at the step 561, which is typically periodic.

Referring to FIG. 5B which illustrates a method 550 for processing devices data, according to an exemplary embodiment of the present invention. Once the end users 700 define the required modules or profiles. For example, the data profiles module 422, the DHP 425, the DAP 427, in the database module 420, the controller module 400 may start implementing the method 550 for processing devices data. The method 550 comprises steps of: receiving, decoding, validating the devices data records from at least one of the devices 100 and the external data sources 200, and tracking the devices 100 availability and malfunction status.

The step 551 consists in receiving the devices data records from at least one of the remote devices 100 and the external data sources 200. The method 550 may either receive and/or request the data from at least one of the remote devices 100 and the external data sources 200.

The step 552 consists in Decoding and validating the received devices data records based on the defined data profile modules 422. At a step 553, a validation check is performed to check whether the received data records are valid or not. If the received data records are not valid (e.g. unknown data type, blacklisted data type or device, etc.), a device notification, for example, “DEVICE_ONLINE & BAD_DATA”, may be generated and stored in the database module 420 at a step 558 to indicate that the corresponding smart device 100 is currently online and that an inaccurate data record was received.

If the received data record is properly decoded and validated, then at a step 554 the received data record is filtered according to the corresponding data type value, time and location filter expression. If a filter is not defined at the data type level, the corresponding data model value, time and location filter expression may be taken into account. Moreover, contextual information received from external data sources 200 may be used during the filtering process at the step 554. At a step 555, a validation check is performed to check whether the filtering is valid or not. If the filtering is not valid, i.e., data record is filtered by an expression filter, then a device notification, for example, “DEVICE_ONLINE & BAD_DATA”, may be generated and stored in the database module 420 to indicate that an inaccurate data record was received from a specific online device 100, data model 114 and data type 112.

The step 556 is executed in case a data record undergoes successfully the filtering process. In this case, the received data record is stored in the database module 420 and a device notification, for example, “DEVICE_ONLINE & GOOD_DATA”, may be generated and stored in the database module 420 at a step 557 to indicate that the corresponding device 100 is online and that an accurate data record was transmitted to the controller module 400.

Upon execution of the steps 551 to 558, the method 550 may picks the next available data record and apply the same above rule to decode and filter the received data. This process may result in the storage of all the received accurate data records in the database module 420, along with corresponding devices notifications to indicate the devices 100 which are online (DEVICE_ONLINE) as well as the data which were filtered (BAD_DATA) or not (GOOD_DATA).

These notifications are then used by the method 550 to track the devices 100 availability status (i.e. online or offline) and the status of the corresponding data types (i.e. working, malfunctioning, blacklisted, unknown).

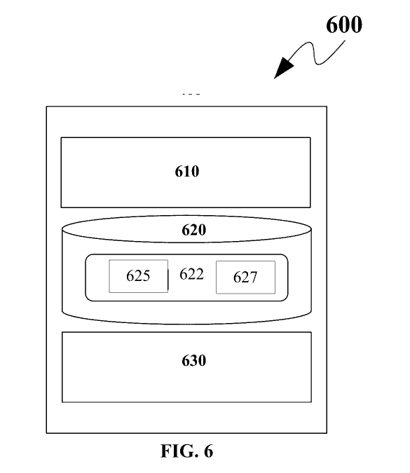

Referring to FIG. 6 which illustrates an apparatus 600 for tracking at least the device 100 status and malfunctions in its sensors through M2M networks 300 (as shown in FIG. 1A-1B), according to an exemplary embodiment, the present invention. The apparatus 600, comprises: at least a processing module 610 capable of processing data received from at least one of the device 100 and the external data source 200; at least a data profiles module 622 capable of describing at least one of the device 100 and at least a sensor 110 of the device 100; and at least a tracking module 630 capable of tracking status of the device 100 and the sensors 110. The data profiles module 622 includes at least one of a device heartbeat profile 625 and a data accuracy profile 627. The data accuracy profile 627 is associated to one of a data type 112 and a data model 114 (as shown in FIGS. 2B & 2C). The device heartbeat profile 627 is associated to at least one of a device detail 118 and a device template 116. A database module 620 is capable of storing: data and notification processed by the processing module 622, the device heartbeat profile 625 and the data accuracy profile 627.

The present invention is applicable without modifications with planned future enhancements/additions to cellular network standards, such as machine-type communication (MTC) or equivalently machine-to-machine (M2M) communications and device-to-device (D2D) communications that may be included in new releases of LTE-A. The present invention may be built as a software module inside the BSs implementing the on/off switching algorithms.

The techniques, devices, subsystems and methods described and illustrated in the various exemplary embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

Moreover, those skilled in the art will appreciate that the means and functions explained herein above may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

1. A system for tracking devices status and malfunctions in a Machine-to-Machine network, the system comprising:
at least a controller module capable of tracking devices status and malfunctions, wherein the controller module having at least one of a processing module, a tracking module, and a database module;
at least a device attached to a mobile or a static entity, wherein the device is having at least one of at least a sensor and at least a device communication module;
at least a data profiles module capable of describing at least one of the device and at least the sensor;
at least a device heartbeat profile and at least a data accuracy profile associated with the data profiles module; and
at least a tracking module capable of tracking devices status and malfunctions,
wherein the device is capable of collecting the data records generated by at least the sensor and transmitting the collected data records to the controller module.

2. The system of claim 1, wherein at least an external data source is communicably connected with the controller module to communicate at least one of stored context based information and data records received from remote devices which are not connected from the controller module.

3. The system of claim 1, wherein at least one of the device heartbeat profile and the data accuracy profile is based on at least one of characteristics of the devices and the contextual information received from the external data sources.

4. The system of claim 1, wherein the device communication module is capable of at least one of collecting data records generated by the sensor and describing the collected data records based on the data profile module.

5. The system of claim 1, wherein the sensor is capable of sensing or detecting at least a characteristic in its surrounding environment.

6. The system of claim 1, wherein the processing module is capable of receiving, decoding, and storing data received from at least one of the device and the external data source in to the database.

7. The system of claim 1, wherein the processing module is capable of translating the data received from at least one of the device and the external data source into notifications based on the accuracy of the received data and the availability of the devices.

8. The system of claim 1, wherein the database module is capable of storing and processing at least one of the data profiles module, the device heartbeat profile, the data accuracy profile, and the notifications.

9. The system of claim 1, wherein the tracking module is capable of tracking at least one of the real-time and the historical devices availability status and sensors status.

10. The system of claim 1, wherein the tracking module is capable of: analyzing at least one of the historical and real-time data notifications, available data profiles module and data models; tracking at least one of the real-time and historical devices availability status during the previous period of time; tracking at least one of the real-time and historical status of the sensors; detecting the malfunctioning sensors; and updating status of devices according to detected changes.

11. The system of claim 1, wherein the data profile module comprising at least one of: at least a data type; at least a data model; at least a device template; and at least a device detail.

12. The system of claim 11, wherein the data type which describes actual data records generated by the sensors comprising at least one of: at least a name; at least a type; at least one of a value expression filter, a time expression filter, a location expression filter; and at least the data accuracy profile.

13. The system of claim 11, wherein the data model which describes a group of data types based on their context comprising at least one of: at least a name; at least a list of associated data types names; and at least the data accuracy profile.

14. The system of claim 11, wherein the device template which describes a group of actual devices grouped within a device template comprising at least one of: at least a name; at least a list of associated data models names; and at least the device heartbeat profile.

15. The system of claim 11, wherein the device detail which describes the actual device comprising at least one of: at least a name; at least a device template name; and
at least the device heartbeat profile.

16. The system of claim 1, wherein the device heartbeat profile which specifies information and rules that are required to at least determine the device availability status is associated to at least one of at least a group of devices and at least a group of data types.

17. The system of claim 1, wherein the device heartbeat profile specifies number of data packets that an online device is expected to send during a given period of time in normal situation.

18. The system of claim 1, wherein the data accuracy profiles specifies a percentage of accurate data which is expected to be received during a given period of time in normal situation from at least one of at least a given data type, the data model, and all data types related to the data model.

19. A method for tracking of devices availability and malfunction, comprising the steps of:
extracting at least one of a device heartbeat profiles and a data accuracy profiles;
extracting notifications for at least the device for a previous time period;
setting the device availability status to one of online and offline; and
setting the status of the corresponding data type or group of data types to any one of ‘unknown’, ‘working’, ‘malfunctioning or blacklisted’ according to predefined data accuracy profiles rules.

20. The method of claim 19, further comprising the steps of:
receiving or requesting the devices data records from at least one of at least the device and at least an external data sources;
decoding and validating the data records received from at least one of the devices and the external data source;
generating and storing at least a device status notification;
filtering the received devices data records based on at least one of a corresponding data type value, time and location filter expression;
storing the received device data records in a database module; and
storing at least a device status notification in the database module.

21. An apparatus for tracking at least a device status and malfunctions in a Mobile-to-Mobile network, comprising:
at least a processing module capable of processing data received from at least one of the device and an external data source;
at least a data profiles module capable of describing at least one of the device and at least a sensor of the device; and
at least a tracking module capable of tracking status and malfunctions of the device and device sensors,
wherein the data profiles module associated with at least one of a device heartbeat profile and a data accuracy profile,
wherein the data accuracy profile is associated to at least one of a data type and at least a data model,
wherein the heartbeat profile is associated to at least one of at least a device detail and at least a device template,
wherein a database module is capable of storing and processing at least one of the data profile module, the device heartbeat profile, the data accuracy profile, and notification processed by the processing module.
